(19) United States
(12) Patent Application Publication
(10) Pub. No.: US 2020/0337802 A1
(43) Pub. Date: Oct. 29, 2020

(54) TELESCOPIC CASING

(71) Applicant: CHI-CHING HUANG, Taoyuan City (TW)

(72) Inventors: CHI-CHING HUANG, Taoyuan City (TW); MEI-HUI KAO, New Taipei City (TW)

(73) Assignee: CHI-CHING HUANG, Taoyuan City (TW)

(21) Appl. No.: 16/392,656

(22) Filed: Apr. 24, 2019

(51) Int. Cl. A61C 1/08; A61C 8/00

(52) U.S. Cl. CPC A61C 1/084; A61C 8/0089

(57) ABSTRACT

A telescopic casing includes first end portion, second end portion, first support spring, third end portion, and second support spring. Each of the first, second, and third end portions has a hollow tubular shape. Top end of first end portion is detachably coupled to dental handpiece. Top end of second end portion is nested by rear end of first end portion. First support spring is disposed in first end portion, wherein one end of first support spring abuts against top end of second end portion and the other end of first support spring abuts against first end portion. Top end of third end portion is nested by rear end of second end portion. Second support spring is disposed in second end portion, wherein one end of second support spring abuts against top end of third end portion and the other end of second support spring abuts against second end portion.

### BACKGROUND OF THE INVENTION

### Field of the Disclosure

The present disclosure relates to a telescopic casing, and more particularly to a telescopic casing for assisting dental implant surgery.

### Description of Related Art

Please refer to FIG. 1A and FIG. 1B. FIG. 1A is a schematic diagram of a conventional dental handpiece 8, and FIG. 1B is a cross-sectional view of a drilling performed by a drill 81 of the dental handpiece 8 in cooperation with a dental implant guide plate 7. The dental handpiece 8 is the lowest-risk and first-grade medical device in dental clinical treatment. It can be used to drill a hole within a tooth for accommodating to fill the implant. The dental handpiece 8 can be utilized to accompany with the dental implant guide plate 7 when drilling, so as to align the drill 81 with the exact right position of the tooth socket 72. In this manner, the successful rate of dental surgery is therefore improved, and the medical risk is thus reduced. Since the dental handpiece 8 has clinical problems such as vibration, shaking and easy slippage when the tooth socket 72 is drilled, it is difficult to accurately align the drill 81 of the handpiece 81 to a certain position of the tooth socket 72. In addition, the dental implant guide plate 7 is usually made of plastic or polymer, and has a thickness of only about 1 to 3 mm. When the drill 81 of the handpiece 8 drills downward by facilitating the dental implant guide plate 7, the axial direction of the drill 81 is still easily deflected and shifted; limitation for the axial direction of the drill 81 is difficult to achieve in clinical condition. If the drilled location is wrong or the drilled direction of the drill 81 is shifted, it might sometimes cause a severe surgical failure; even worse, sometimes the sinus membrane within the upper jaw could be punctured, or the chin nerve of the lower jaw could be broken.

Hence, how to reduce slippage of the dental handpiece 8 during drilling and reduce deviation of the drilling direction is worthy of consideration by those who have ordinary knowledge in the field.

### SUMMARY OF THE INVENTION

In order to solve the above problems, it is an object of the present invention to provide a telescopic casing, which prevents the deviation of drilling direction of dental handpiece and avoids slippage of the dental handpiece during drilling.

According to an exemplary embodiment, a telescopic casing adapted to be assembled in a dental handpiece is provided. The telescopic casing includes a first end portion, a second end portion, at least one first support spring, a third end portion, and at least one second support spring. The first end portion has a hollow tubular shape, wherein a top end of the first end portion is detachably coupled to the dental handpiece. The second end portion has a hollow tubular shape, wherein a top end of the second end portion is nested by a rear end of the first end portion. The first support spring is disposed in the first end portion, wherein one end of the first support spring abuts against the top end of the second end portion and the other end of the first support spring abuts against the first end portion. The third end portion has a hollow tubular shape, wherein a top end of the third end portion is nested by a rear end of the second end portion. The second support spring is disposed in the second end portion, wherein one end of the second support spring abuts against the top end of the third end portion and the other end of the second support spring abuts against the second end portion.

According to another exemplary embodiment, a telescopic casing adapted to be fixed on a dental implant guide plate is provided, wherein the dental implant guide plate includes at least one concave hole. The telescopic casing includes a first end portion, a second end portion, at least one first support spring, a third end portion, and at least one second support spring. The first end portion has a hollow tubular shape. The second end portion has a hollow tubular shape, wherein a top end of the second end portion is nested by a rear end of the first end portion. The first support spring is disposed in the first end portion, wherein one end of the first support spring abuts against the top end of the second end portion and the other end of the first support spring abuts against the first end portion. The third end portion has a hollow tubular shape, wherein a top end of the third end portion is nested by a rear end of the second end portion. The second support spring is disposed in the second end portion, wherein one end of the second support spring abuts against the top end of the third end portion and the other end of the second support spring abuts against the second end portion. The third end portion includes at least one protrusion block, and a position of the protrusion block is corresponding to a position of the concave hole.

According to another exemplary embodiment, a telescopic casing adapted to be locked to a dental implant guide plate is provided, wherein the dental implant guide plate includes an internal screw thread. The telescopic casing includes a first end portion, a second end portion, at least one first support spring, a third end portion, and at least one second support spring. The first end portion has a hollow tubular shape. The second end portion has a hollow tubular shape, wherein a top end of the second end portion is nested by a rear end of the first end portion. The first support spring is disposed in the first end portion, wherein one end of the first support spring abuts against the top end of the second end portion and the other end of the first support spring abuts against the first end portion. The third end portion has a hollow tubular shape, wherein a top end of the third end portion is nested by a rear end of the second end portion. The second support spring is disposed in the second end portion, wherein one end of the second support spring abuts against the top end of the third end portion and the other end of the second support spring abuts against the second end portion. A surface of the third end portion includes an external screw thread, and the external screw is corresponding to the internal screw thread.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1A is a schematic diagram of a conventional dental handpiece 8.

FIG. 1B is a cross-sectional view of a drilling performed by a drill 81 of the dental handpiece 8 in cooperation with a dental implant guide plate 7.

FIG. 2A is a cross-section view of a telescopic casing 10 according to a first embodiment of the present invention.

FIG. 2B is a three-dimensional view of the telescopic casing 10.

FIG. 2C is a schematic diagram showing the telescopic casing 10 assembled to the dental handpiece 8.

FIG. 3 is a schematic diagram showing the telescopic casing 10 when the volume is shortened.

FIG. 4A and FIG. 4B are schematic diagrams showing a drilling performed by the dental handpiece 8 in cooperation with the telescopic casing 10.

FIG. 5 is a three-dimensional view of the telescopic casing 10 having a plurality of graduations 13G.

FIG. 6A is a three-dimensional view of a telescopic casing 20 according to a second embodiment of the present invention.

FIG. 6B is a schematic diagram showing the telescopic casing 20 being engaged with the dental implant guide plate 7.

FIG. 7A is a schematic diagram showing a telescopic casing 30 of a third embodiment being locked to the dental implant guide plate 7.

FIG. 7B is a cross-sectional view showing the telescopic casing 30 locked to the dental implant guide plate 7.

FIG. 7C is a schematic diagram showing the drill 81 along the axial direction of the telescopic casing 30.

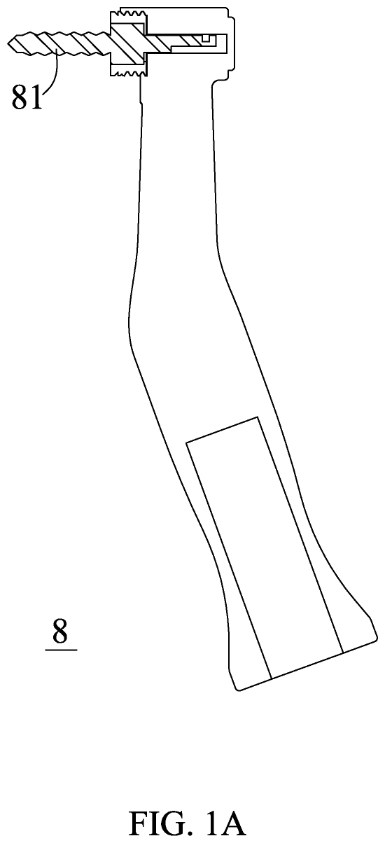

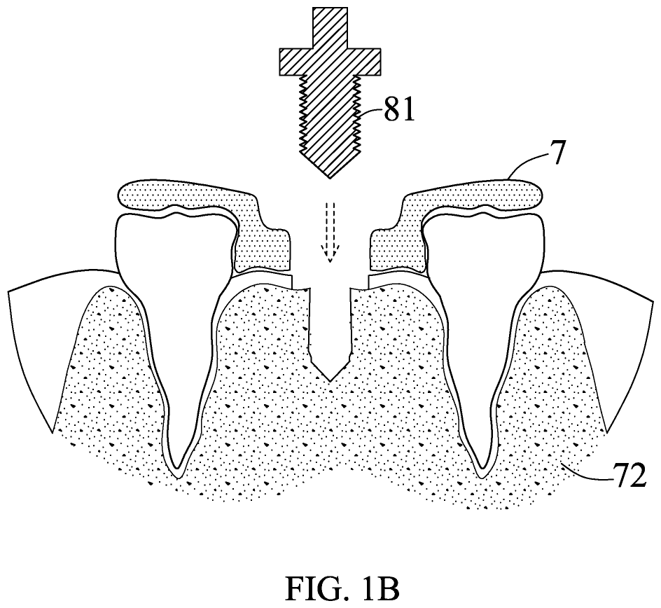

### DESCRIPTION OF THE INVENTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

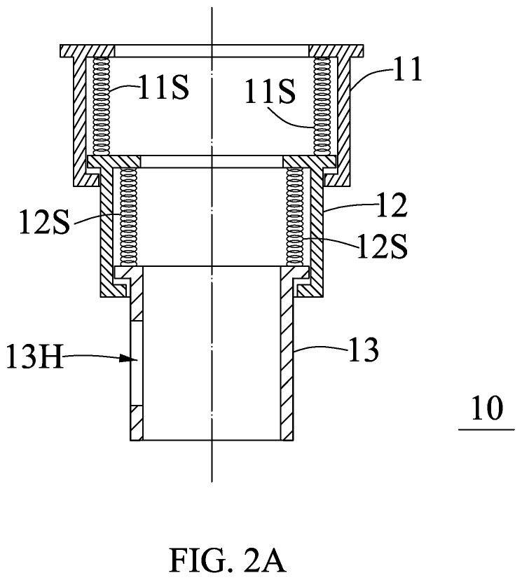

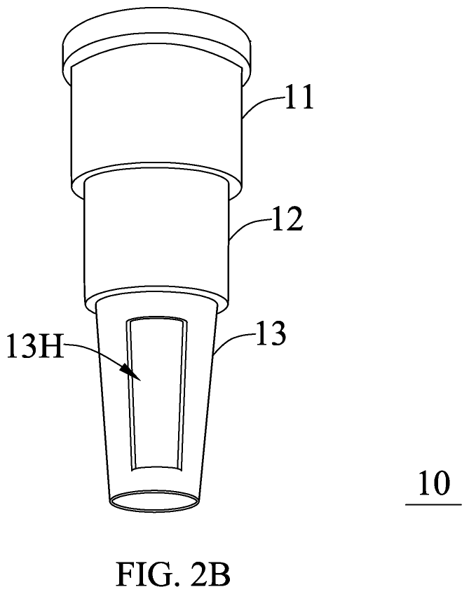

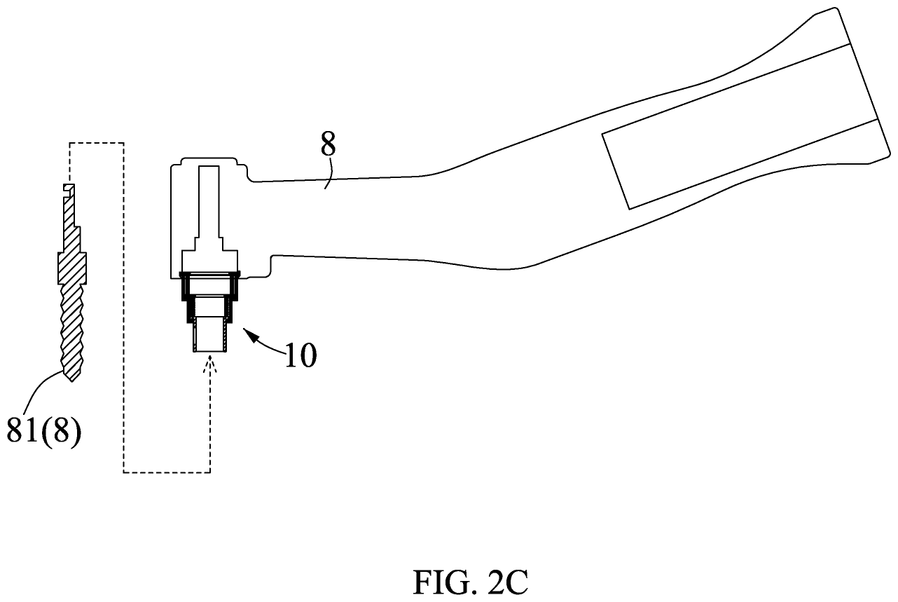

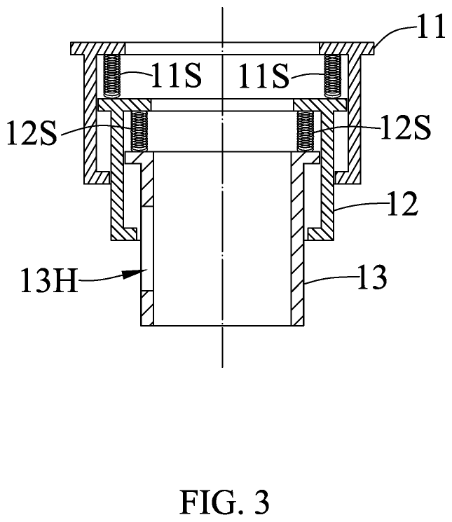

Please refer to FIG. 2A, FIG. 2B, and FIG. 2C. FIG. 2A is a cross-section view of a telescopic casing 10 according to a first embodiment of the present invention, FIG. 2B is a three-dimensional view of the telescopic casing 10, and FIG. 2C is a schematic diagram showing the telescopic casing 10 assembled to the dental handpiece 8. As shown in FIG. 2C, the telescopic casing 10 is assembled in a dental handpiece 8. When the telescopic casing 10 is assembled in the dental handpiece 8, a drill 81 is surrounded by the telescopic casing 10. As shown in FIG. 2A and FIG. 2B, the telescopic casing 10 includes a first end portion 11, a second end portion 12, at least one first support spring 11S (two first support springs 11S are used as an example in this embodiment), a third end portion 13, and at least one second support spring 12S (two second support springs 12S are used as an example in his embodiment). The first end portion 11, the second end portion 12, and the third end portion 13 have a hollow tubular shape of different sizes, wherein the first end portion 11 has the largest diameter, and the third end portion 13 has the smallest diameter. In addition, the top end of the first end portion 11 is detachably coupled to the handpiece 8 (see FIG. 2B-2C). That is to say, the telescopic casing 10 and the handpiece 8 are coupled to each other by inserting or snapping the first end portion 11 of the telescopic casing 10 into the dental handpiece 8, so that the top end of the first end portion 11 can be detached or combined by a tight fit or a snap lock manner. Furthermore, a top end of the second end portion 12 is nested by a rear end of the first end portion 11. The two first support springs 11S are disposed in the first end portion 11, wherein the lower end of the first support springs 11S abuts against the top end of the second end portion 12, and the upper end of the first support spring 11S abuts against the first end portion 11. The top end of the second end portion 12 is pushed downward by the first support spring 11S, so that the top end of the second end portion 12 abuts against the rear end of the first end portion 11. In this manner, when the second end portion 12 or the first end portion 11 is subjected to an external force, the first support spring 11S is compressed to shorten the length of the first support spring 11S, so that the top end of the second end portion 12 and the first end portion 11 are approached to each other (please refer to FIG. 3, which is a schematic diagram showing the telescopic casing 10 when the volume is shortened).

Similarly, the top end of the third end portion 13 is nested by the rear end of the second end portion 12. The two second support springs 12S are disposed within the second end portion 12, wherein the lower end of the second support spring 12S abuts against the top end of the third end portion 13, and the upper end of the second support spring 12S abuts against the second end portion 12. The top end of the third end portion 13 is subjected to the pushing outward tension of the second supporting spring 12S, so that the top end of the third end portion 13 can abuts against the rear end of the second end portion 12. In this manner, when the third end portion 13 or the second end portion 12 is subjected to an external force, the second support spring 12S is compressed to shorten the length of the second support spring 12S, thereby making the top end of the third end portion 13 move toward the top end of the second end portion 12 (i.e., the top end of third end portion 13 and the top end of the second end portion 12 are approached to each other, see FIG. 3). In addition, the third end portion 13 includes at least one through-hole 13H. When the dental implant surgery is carried out, the cooling water can enter and contact the drill 81 of the dental handpiece 8 through the through-hole 13H, to cool down the temperature of the drill 81.

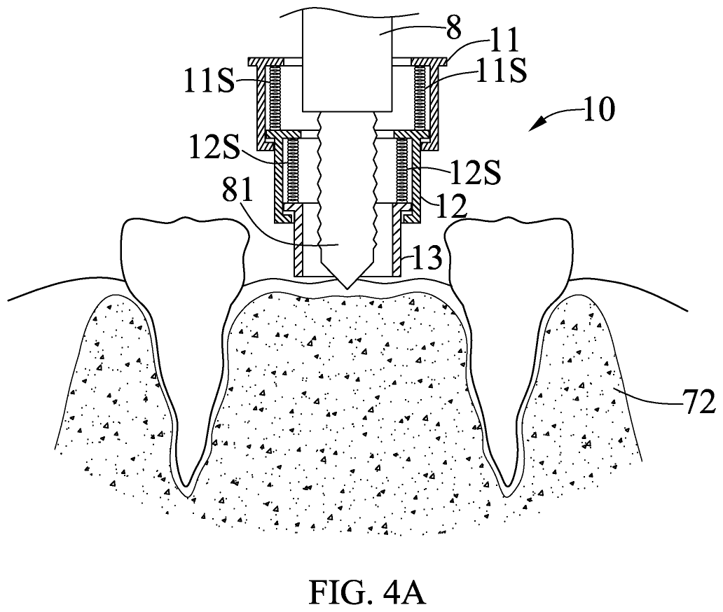

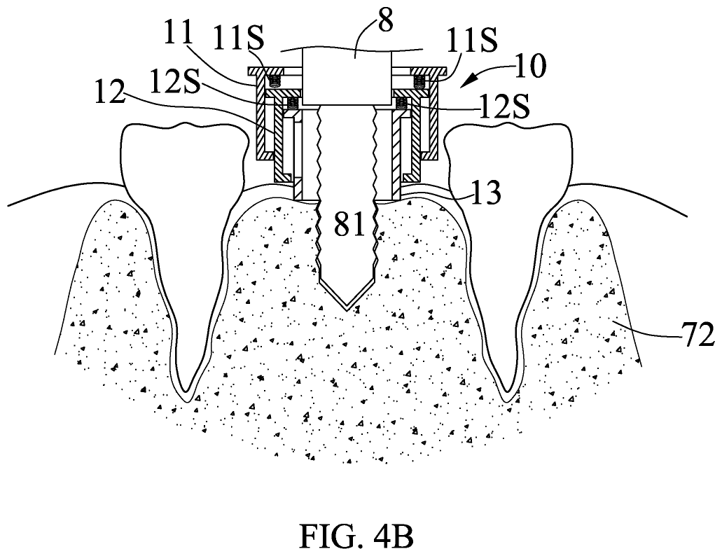

Please refer to FIG. 4A and FIG. 4B. FIG. 4A and FIG. 4B are schematic diagrams showing a drilling performed by the dental handpiece 8 in cooperation with the telescopic casing 10. The telescopic casing 10 can facilitate the drill 81 to adjust its axial direction and guide the drill 81 to aim at the position set of the tooth socket 72 before the telescopic casing 10 moving downward. Then, when the telescopic casing 10 moves downward and touches the tooth socket 72, the first end portion 11, the second end portion 12 and the third end portion 13 are pushed by the tooth socket 72, and the first support spring 11S and the second support spring 12S are correspondingly compressed. Therefore, the length of the telescopic casing 10 is shortened on the axial direction, and the drill 81 is exposed from the inside of the telescopic casing 10, so that the drill 81 can be drilled downward to reach the tooth socket 72, namely the drilling process is carried out at location of the tooth socket 72. The drill 81 can be drilled downward along the axial direction of the telescopic casing 10, so that the deviation of the drilling direction is reduced. Besides, the telescopic casing 10 can also prevent the dental handpiece 8 from slipping when the telescopic casing 10 abuts against the surface of the tooth socket 72 (see FIG. 4B). Therefore, the telescopic casing 10 can assist the dental handpiece 8 to accurately perform the drilling process, assist the dentist to aim at the drilled position of the tooth socket 72, and also assist in guiding the drilling direction and angle, thereby surgical deflection and offset caused by clinical error is thus maximally reduced.

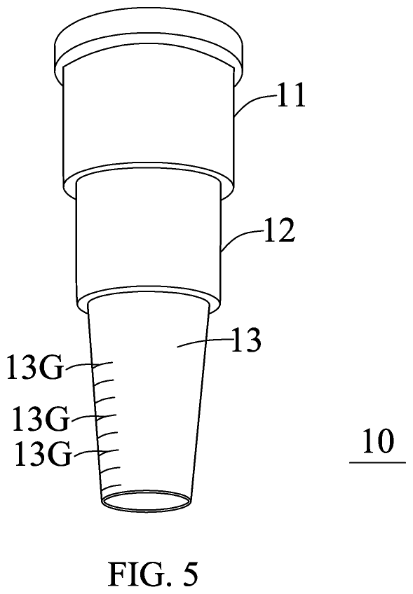

Please refer to FIG. 5. FIG. 5 is a three-dimensional view of the telescopic casing 10 having a plurality of graduations 13G. In other embodiments, the outer surface of the third end portion 13 has a plurality of graduations 13G for measuring the drilling depth. When the drill 81 is drilled downward, it is pressed by the tooth socket 72. A relative position is changed between the third end portion 13 and the second end portion 12, so that the dentist can read the value of the graduations 13G from the surface of the third end portion 13, so as to read and measure the drilled depth of the drill 81.

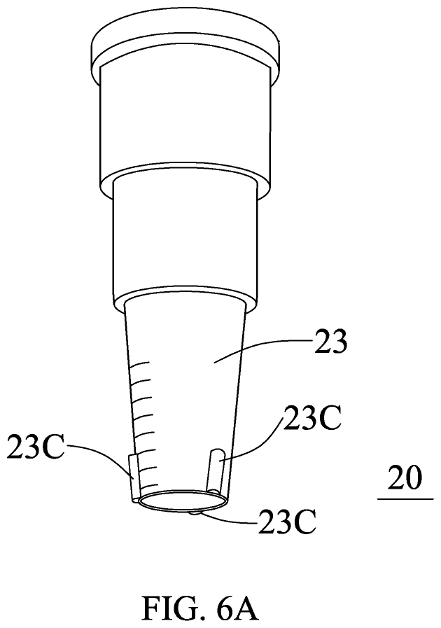

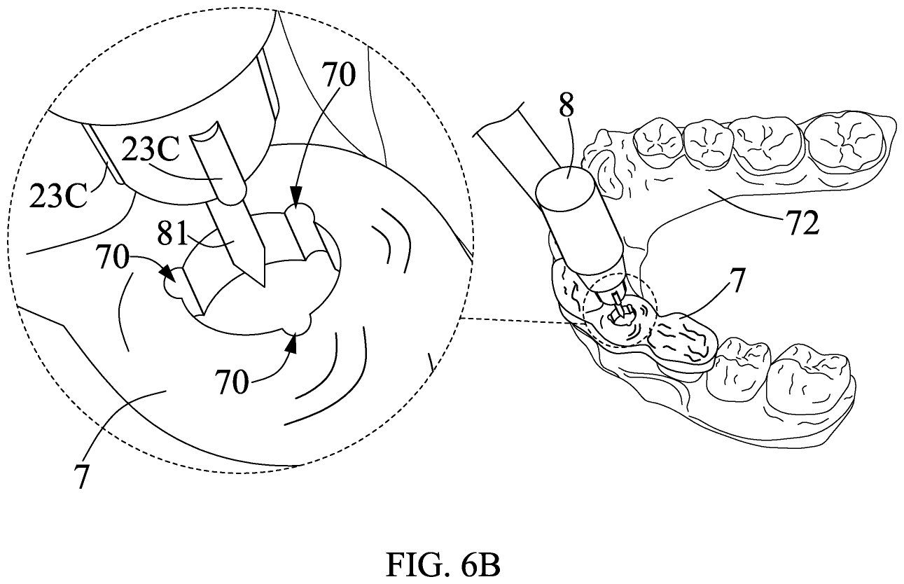

Please refer to FIG. 6A and FIG. 6B. FIG. 6A is a three-dimensional view of a telescopic casing 20 according to a second embodiment of the present invention, and FIG. 6B is a schematic diagram showing the telescopic casing 20 being engaged with the dental implant guide plate 7. The difference between the telescopic casing 20 and the telescopic casing 10 is that: the telescopic casing 20 of the embodiment shown in FIG. 6A and FIG. B can be used to accommodate a dental implant guide plate 7. In detail, the dental implant guide plate 7 includes at least one concave hole 70 (in this embodiment, three concave holes 70 are used as an example), and the rear end of the third end portion 23 of the telescopic casing 20 includes at least one protrusion block 23C (in this embodiment, three protrusion blocks 23C are used as an example), wherein positions of the protrusion blocks 23C are corresponded to the positions of the concave hole 70, that is, the three protrusion blocks 23C correspond to the three concaves 70 respectively. Therefore, the telescopic casing 20 can be engaged with the three concave holes 70 of the dental implant guide plate 7 via the three protrusion blocks 23C without being assembled to the dental handpiece 8, so that the telescopic casing 20 in this embodiment and the dental implant guide plate 7 are coupled and engaged to each other. Therefore, the axial direction of the telescopic casing 20 is fixed by the dental implant guide plate 7. When the drill 81 of the dental handpiece 8 moves downward to apporach the tooth socket 72, it can drill downward along the exact axial direction of the telescopic casing 20, so that offset or deviation of the direction/angle can be prevented, thus the axial direction stability can be ensured.

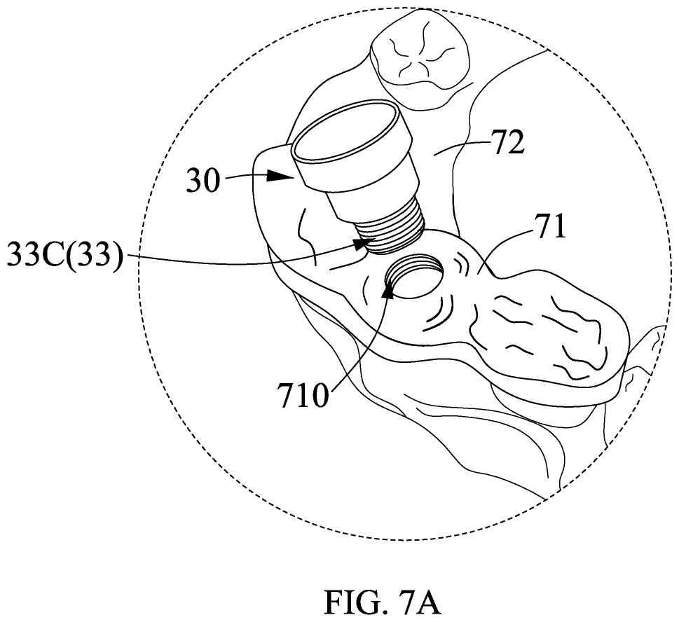

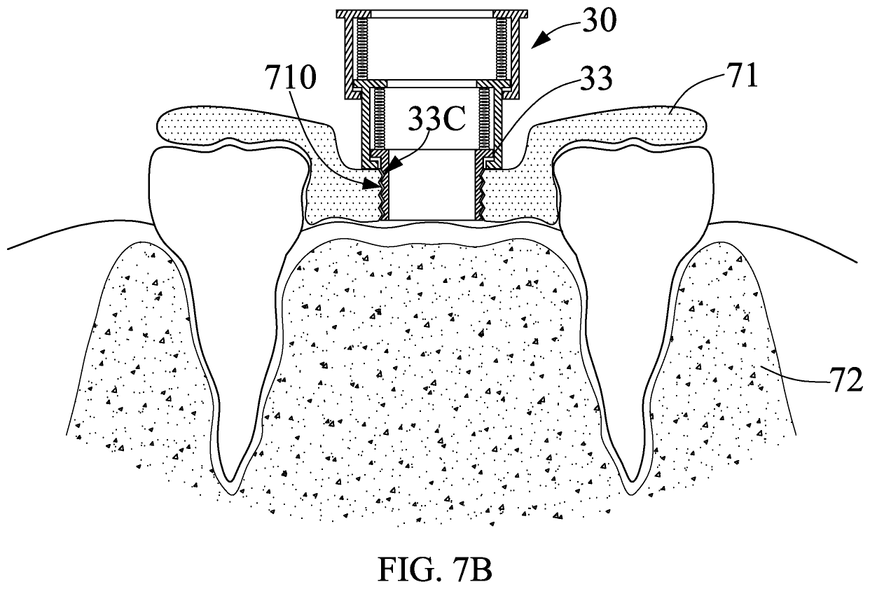

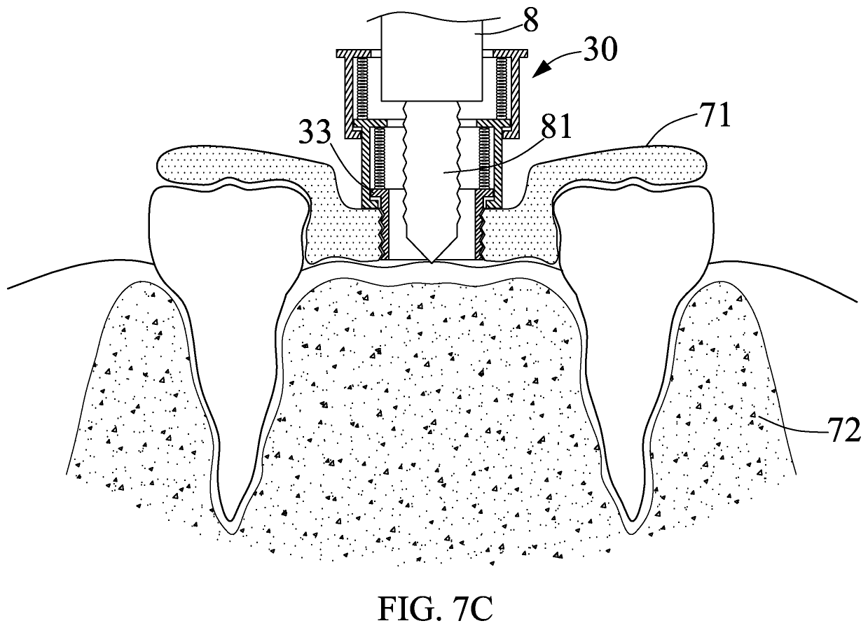

Please refer to FIG. 7A, FIG. 7B and FIG. 7C. FIG. 7A is a schematic diagram showing a telescopic casing 30 of a third embodiment being locked to the dental implant guide plate 7, FIG. 7B is a cross-sectional view showing the telescopic casing 30 locked to the dental implant guide plate 7, and FIG. 7C is a schematic diagram showing the drill 81 along the axial direction of the telescopic casing 30. The difference between the telescopic casing 30 and the telescopic casing 20 is that: the telescopic casing 30 of this embodiment can be locked to a dental implant guide plate 71 by means of a screwed mechanism. In detail, an internal screw thread 710 may be disposed on the dental implant guide plate 71, and the outer surface of the third end portion 33 of the telescopic casing 30 has an external screw thread 33C, wherein the external screw thread 33C corresponds to the internal screw thread 710. That is, the external screw thread 33C of the third end portion 33 can be screwed onto the internal screw thread 710 of the dental implant guide plate 71. Therefore, the telescopic casing 30 can be locked and fixed to the dental implant guide plate 71, not need to attach on the handpiece 8 in advance. Thus, the axial direction of the telescopic casing 30 is fixed by the dental implant guide plate 71, and therefore the drill 81 can be drilled downward along the axial direction of the telescopic casing 30, so that the deviation of the drilling direction of the drill 81 can be reduced.

In summary, the telescopic casing of the present invention can prevent the deviation of the drilling direction of the dental handpiece and slippage during drilling, and has the advantage of fixing drilling direction.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A telescopic casing, adapted to be assembled in a dental handpiece, the telescopic casing comprising:
a first end portion, having a hollow tubular shape, wherein a top end of the first end portion is detachably coupled to the dental handpiece;
a second end portion, having a hollow tubular shape, wherein a top end of the second end portion is nested by a rear end of the first end portion;
at least one first support spring, disposed in the first end portion, wherein one end of the first support spring abuts against the top end of the second end portion and the other end of the first support spring abuts against the first end portion;
a third end portion, having a hollow tubular shape, wherein a top end of the third end portion is nested by a rear end of the second end portion; and
at least one second support spring, disposed in the second end portion, wherein one end of the second support spring abuts against the top end of the third end portion and the other end of the second support spring abuts against the second end portion.

2. The telescopic casing in claim 1, wherein a rear end of the third end portion further comprises at least one protrusion block.

3. The telescopic casing in claim 1, wherein a surface of the third end portion further comprises an external screw thread.

4. The telescopic casing in claim 1, wherein a surface of the third end portion further comprises at least one through-hole, and the through-hole penetrates through the surface.

5. The telescopic casing in claim 1, wherein a surface of the third end portion further comprises a plurality of graduations.

6. A telescopic casing, adapted to be fixed on a dental implant guide plate, the dental implant guide plate comprising at least one concave hole, the telescopic casing comprising:
a first end portion, having a hollow tubular shape;
a second end portion, having a hollow tubular shape, wherein a top end of the second end portion is nested by a rear end of the first end portion;
at least one first support spring, disposed in the first end portion, wherein one end of the first support spring abuts against the top end of the second end portion and the other end of the first support spring abuts against the first end portion;
a third end portion, having a hollow tubular shape, wherein a top end of the third end portion is nested by a rear end of the second end portion; and
at least one second support spring, disposed in the second end portion, wherein one end of the second support spring abuts against the top end of the third end portion and the other end of the second support spring abuts against the second end portion;
wherein the third end portion comprises at least one protrusion block, and a position of the protrusion block is corresponding to a position of the concave hole.

7. The telescopic casing in claim 6, wherein a surface of the third end portion further comprises at least one through-hole, and the through-hole penetrates through the surface.

8. The telescopic casing in claim 6, wherein a surface of the third end portion further comprises a plurality of graduations.

9. A telescopic casing, adapted to be locked to a dental implant guide plate, the dental implant guide plate comprising an internal screw thread, the telescopic casing comprising:
a first end portion, having a hollow tubular shape;
a second end portion, having a hollow tubular shape, wherein a top end of the second end portion is nested by a rear end of the first end portion;
at least one first support spring, disposed in the first end portion, wherein one end of the first support spring abuts against the top end of the second end portion and the other end of the first support spring abuts against the first end portion;
a third end portion, having a hollow tubular shape, wherein a top end of the third end portion is nested by a rear end of the second end portion; and
at least one second support spring, disposed in the second end portion, wherein one end of the second support spring abuts against the top end of the third end portion and the other end of the second support spring abuts against the second end portion;
wherein a surface of the third end portion comprises an external screw thread, and the external screw is corresponding to the internal screw thread.

10. The telescopic casing in claim 9, wherein a surface of the third end portion further comprises at least one through-hole, and the through-hole penetrates through the surface.

11. The telescopic casing in claim 9, wherein a surface of the third end portion further comprises a plurality of graduations.
